(19) United States
(12) Patent Application Publication
(10) Pub. No.: US 2017/0007013 A1
(43) Pub. Date: Jan. 12, 2017

(54) ORAL HYGIENE INSTRUMENT AND METHOD

(71) Applicant: Marielle Pariseau, Midway, UT (US)

(72) Inventor: Marielle Pariseau, Midway, UT (US)

(21) Appl. No.: 15/190,551

(22) Filed: Jun. 23, 2016

Related U.S. Application Data
(60) Provisional application No. 62/190,029, filed on Jul. 8, 2015.

(51) Int. Cl. A46B 15/00; A46B 11/00; A46B 5/02; A61C 15/04; A46B 9/04

(52) U.S. Cl. CPC A46B 15/0071; A61C 15/041; A61C 15/046; A46B 9/04; A46B 5/021; A46B 15/0087; A46B 5/026; A46B 11/0003; A46B 2200/1066

(57) ABSTRACT

An oral hygiene instrument that includes a flossing member and a brushing member at opposite ends of an elongated handle member. An oral hygiene substance, such as xylitol, may be applied to a flossing filament of the flossing member and bristles of the brushing member. The oral hygiene instrument may include one or more coupling mechanisms at one or both of the ends of the elongated handle member to selectively engage one or both of the flossing member and the brushing member. The oral hygiene instrument may also include one or more digit placement pads that promote a positioning of an oral hygiene instrument within a user's hand that is useful for flossing and brushing a user's teeth. These digit placement pads may indicate a proper sequence of flossing and brushing a user's teeth.

### RELATED APPLICATION

This application claims the benefit of U.S. Provisional Application No. 62/190,029, filed Jul. 8, 2015, the entire disclosure of which is incorporated herein by reference.

### BACKGROUND

Personal hygiene and cleanliness are important considerations in order to maintain one's health. Public restrooms facilitate maintaining one's hands clean, as most of these facilities provide a sink and soap. Hand sanitation stations where a hand antiseptic is provided are also becoming more common in many public areas.

Oral hygiene is also an important consideration in order to maintain one's health. Unfortunately, the tools necessary to maintain a high level of oral hygiene are not as publicly accessible as soap and hand sanitizer. This is especially true if one spends most of the day away from the home. Oftentimes it is inconvenient to carry on one's person a toothbrush and toothpaste or floss. These tools are usually not provided in public places, unlike soap and hand sanitizer. The result of this lack of accessibility is that most people only brush and floss their teeth in their home bathroom. The exclusive use of the home bathroom for oral hygiene may be sufficiently frequent to avoid some serious oral health issues. However, one should brush and floss after every meal in order to avoid dental problems, such as dental cavities, gingivitis, periodontal (gum) diseases and bad breath.

Embodiments of the disclosure contained herein provide an oral hygiene instrument, system, and method.

### SUMMARY

An oral hygiene instrument according to some embodiments may include an elongated handle member that has a top surface, a bottom surface, a first end and a second end. The instrument may include a flossing member at the first end of the elongated handle member, the flossing member may have a filament holding member and a flossing filament for flossing between teeth. The instrument may also include a brushing member at the second end of the elongated handle member, the brushing member may have a plurality of substantially parallel bristles for brushing teeth. The instrument may further include an oral hygiene substance applied to the flossing filament of the flossing member and the bristles of the brushing member. In some embodiments, this oral hygiene substance may include xylitol.

In some embodiments of the oral hygiene instrument, the flossing filament may be substantially perpendicular to the bristles. In some embodiments, the oral hygiene instrument may include one or more coupling mechanisms at one or both of the first and second ends of the elongated handle member to selectively engage one or both of the flossing member and the brushing member. In some embodiments of the oral hygiene instrument, a portion of the elongated handle member may be curved about an axis such that at least a portion of the top surface of the elongated handle member forms a convex outer surface that faces away from the axis and at least a portion of the bottom surface of the elongated handle member forms a concave inner surface that faces toward the axis. The brushing member may be positioned such that the plurality of bristles extend away from the axis. In some embodiments of the oral hygiene instrument, the flossing filament may be substantially parallel to the axis.

In some embodiments of the oral hygiene instrument, a first thumb placement pad and a second thumb placement pad may be positioned at or near the first end of the elongated handle member, the first and second thumb placement pads being configured such that when a user places a thumb on the first or second thumb placement pads and grasps the elongated handle member, the oral hygiene instrument may be positioned to floss the user's teeth. The oral hygiene instrument may also include a third thumb placement pad and a forth thumb placement pad positioned at or near the second end of the elongated handle member, the third and fourth thumb placement pads being configured such that when a user places a thumb on the third or fourth thumb placement pads and grasps the elongated handle member, the oral hygiene instrument may be positioned to brush the user's teeth.

In some embodiments of the oral hygiene instrument, the first, second, third, and fourth thumb placement pads may include symbols that indicate a proper sequence of brushing and flossing. In some embodiments of the oral hygiene instrument, the first, second, third, and fourth thumb placement pads may include an anti-slip texture.

An oral hygiene instrument according to some embodiments may include an elongated handle member including a top surface, a bottom surface, a brushing end, and a flossing end. The oral hygiene instrument may include a brushing member at the brushing end, the brushing member may include a plurality of bristles for brushing teeth. The oral hygiene instrument may include a flossing member at the second end, the flossing member may include a flossing filament holding member and a flossing filament for flossing between teeth. The oral hygiene instrument may include a first thumb placement pad and a second thumb placement pad positioned on the elongated handle member at or near the flossing end, the first thumb placement pad may be positioned on the top surface of the elongated handle member and the second thumb placement pad may be positioned on the bottom surface of the elongated handle member. The oral hygiene instrument may include a third thumb placement pad and a fourth thumb placement pad positioned on the elongated handle member at or near the brushing end, the third thumb placement pad may be positioned on the bottom surface of the elongated handle member and the fourth thumb placement pad may be positioned on the top surface of the elongated handle member.

In some embodiments of the oral hygiene instrument, each of the first, second, third, and fourth thumb placement pads may include a different symbol that indicates a proper sequence of brushing and flossing. In some embodiments of the oral hygiene instrument, each different symbol may be a number. In some embodiments of the oral hygiene instrument, the first, second, third, and fourth thumb placement pads may include an anti-slip texture.

In some embodiments of the oral hygiene instrument, at least a portion of the elongated handle member may be curved about an axis such that the top surface of the elongated handle member forms a convex outer surface that faces away from the axis and the bottom surface of the elongated handle member forms a concave inner surface that faces toward the axis, and the brushing member may be positioned such that the plurality of bristles extend away from the axis.

In some embodiments of the oral hygiene instrument, the flossing filament may be substantially parallel to the axis. In some embodiments, the oral hygiene instrument may further include an oral hygiene substance pre-applied to the bristles of the brushing member and the flossing filament of the flossing member. In some embodiments of the oral hygiene instrument, the oral hygiene substance may include xylitol.

A method for an oral hygiene instrument according to some embodiments may include obtaining an oral hygiene instrument that includes an elongated handle member including a top surface, a bottom surface, a brushing end, and a flossing end, a brushing member at the brushing end, the brushing member including a plurality of bristles for brushing teeth, a flossing member at the second end, the flossing member including a flossing filament holding member and a flossing filament for flossing between teeth, a first thumb placement pad and a second thumb placement pad positioned on the elongated handle member at or near the flossing end, the first thumb placement pad being positioned on the top surface of the elongated handle member and the second thumb placement pad being positioned on the bottom surface of the elongated handle member, and a third thumb placement pad and a fourth thumb placement pad positioned on the elongated handle member at or near the brushing end, the third thumb placement pad being positioned on the top surface of the elongated handle member and the fourth thumb placement pad being positioned on the bottom surface of the elongated handle member.

The method may further include grasping the oral hygiene instrument with a thumb on the first thumb placement pad and flossing between a user's upper teeth, grasping the oral hygiene instrument with a thumb on the second thumb placement pad and flossing between the user's lower teeth, grasping the oral hygiene instrument with a thumb on the third thumb placement pad and brushing the user's upper teeth, and grasping the oral hygiene instrument with a thumb on the fourth thumb placement pad and brushing the user's lower teeth.

### DESCRIPTION OF DRAWINGS

FIG. 1 is a first perspective view of an oral hygiene instrument according to one embodiment of the present disclosure.

FIG. 2 is a second perspective view of the oral hygiene instrument according to one embodiment of the present disclosure.

FIG. 3 is a side view of the oral hygiene instrument according to one embodiment of the present disclosure.

FIG. 4 is a top planar view of the oral hygiene instrument according to one embodiment of the present disclosure.

FIG. 5 is a bottom planar view of the oral hygiene instrument according to one embodiment of the present disclosure.

FIG. 6 illustrates a hand grasping an oral hygiene instrument in a position that is useful for flossing between a user's upper teeth.

FIG. 7 illustrates a hand grasping an oral hygiene instrument in a position that is useful for flossing between a user's lower teeth.

FIG. 8 illustrates a hand grasping an oral hygiene instrument in a position that is useful for brushing a user's upper teeth.

FIG. 9 illustrates a hand grasping an oral hygiene instrument in a position that is useful for brushing a user's lower teeth.

FIG. 10 illustrates an oral hygiene instrument dispenser according to one embodiment of the present disclosure.

FIG. 11 illustrates a receptacle according to one embodiment of the present disclosure.

FIG. 12 illustrates a flow of an oral hygiene method according to one embodiment of the present disclosure.

### DETAILED DESCRIPTION

At a high level, this disclosure describes an oral hygiene instrument, a system that incorporates the oral hygiene instrument, and a method for using the oral hygiene instrument. The oral hygiene instrument, according to some embodiments, may include an elongated handle member that has a top surface, a bottom surface, a first end and a second end. The instrument may include a flossing member at the first end of the elongated handle member, the flossing member may have a filament holding member and a flossing filament for flossing between teeth. The instrument may also include a brushing member at the second end of the elongated handle member, the brushing member may have a plurality of substantially parallel bristles for brushing teeth. The instrument may further include an oral hygiene substance, such as xylitol, applied to the flossing filament of the flossing member and the bristles of the brushing member.

Oral hygiene instruments, according to some embodiments, may include a first thumb placement pad and a second thumb placement pad that may be positioned at or near the first end of an elongated handle member, the first and second thumb placement pads may be configured such that when a user places a thumb on the first or second thumb placement pads and grasps the elongated handle member, the oral hygiene instrument is positioned to floss the user's teeth. The oral hygiene instrument may also include a third thumb placement pad and a forth thumb placement pad positioned at or near the second end of the elongated handle member, the third and fourth thumb placement pads may be configured such that when a user places a thumb on the third or fourth thumb placement pads and grasps the elongated handle member, the oral hygiene instrument is positioned to brush the user's teeth. A method for using an oral hygiene instrument according to some embodiments may employ the aforementioned thumb placement pads to indicate a proper sequence of brushing and flossing a user's teeth.

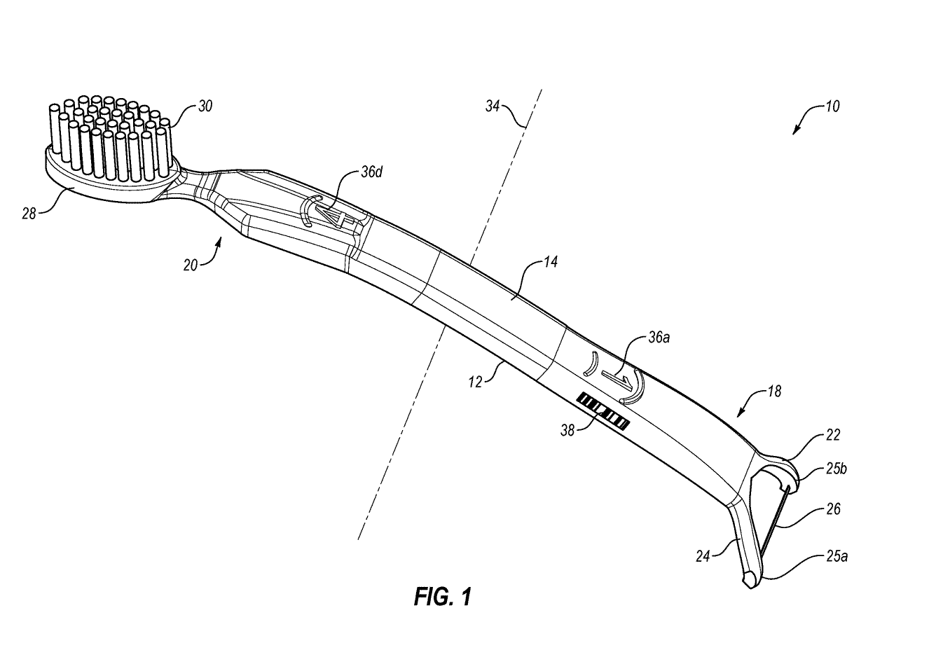

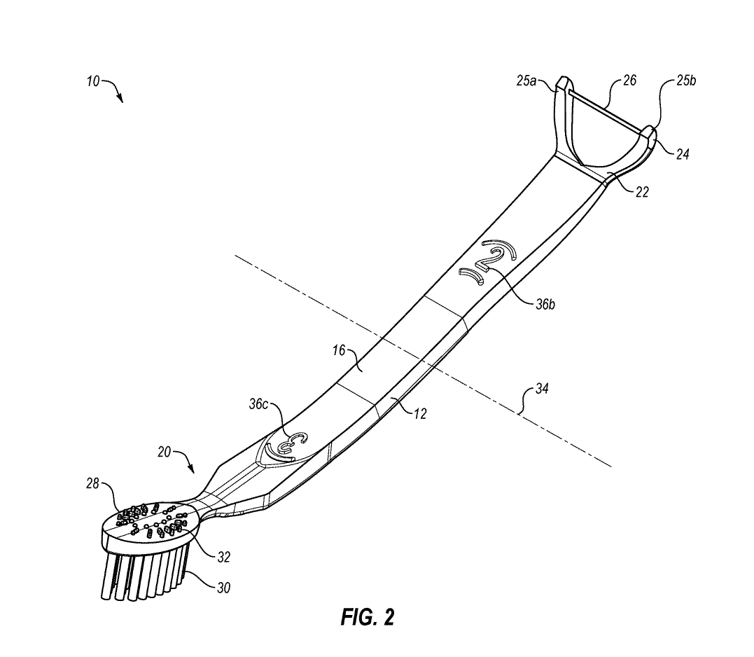

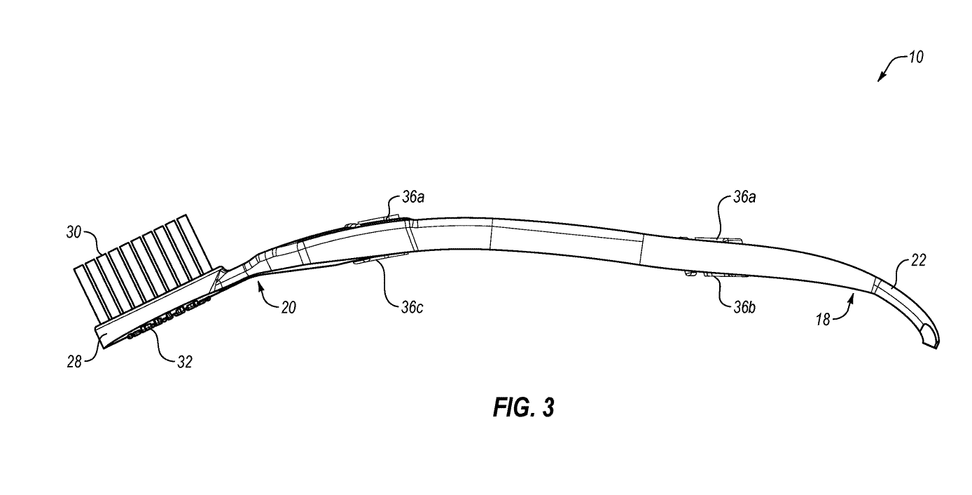

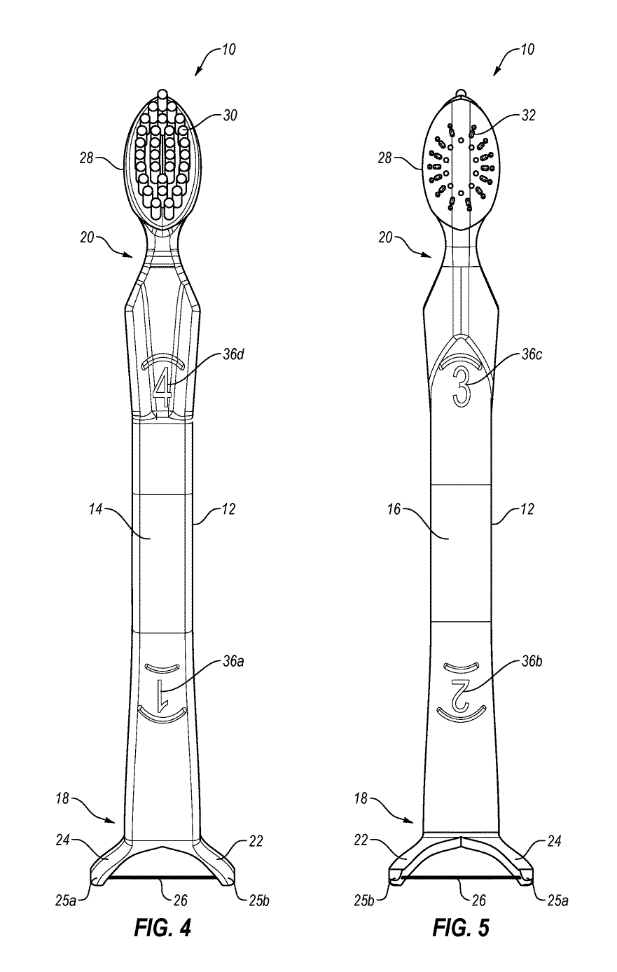

FIG. 1 illustrates a first perspective view of an oral hygiene instrument 10, according to one embodiment. FIG. 2 illustrates a second perspective view of oral hygiene instrument 10. FIG. 3 illustrates a side view of oral hygiene instrument 10. FIG. 4 illustrates a top planar view of oral hygiene instrument 10. FIG. 5 illustrates a bottom planar view of oral hygiene instrument 10.

As can be seen in FIGS. 1-5, oral hygiene instrument 10 may include an elongated handle member 12. Elongated handle member 12 may include a top surface 14 and a bottom surface 16. Elongated handle member 12 may also include a first end 18 and a second end 20. A flossing member 22 may be positioned at first end 18 of elongated handle member 12. Flossing member 22 may include a filament holding member 24 and a flossing filament 26 for flossing between teeth. Filament holding member 24 may have a Y-shape with holding arms 25a and 25b. Flossing filament 26 may be secured to filament holding member 24 at each of holding arms 25a and 25b to provide tension to flossing filament 26. Flossing filament 26 may be any suitable flossing filament such as, for example, a string-type filament with a circular cross-sectional shape or a tape-type filament with a rectangular cross-sectional shape. Flossing filament 26 may have an oral hygiene substance applied to its outer surface. This oral hygiene substance may include, in whole or in part, xylitol.

A brushing member 28 may be positioned at second end 20 of elongated handle member 12. Brushing member 28 may include a plurality of substantially parallel bristles 30. Bristles 30 may be any suitable size and diameter, such as 0.16 millimeters in diameter. Any number of individual bristles 30 may be secured to brushing member 28 and the bristles 30 may be made of any suitable material including, but not limited to, nylon. Brushing member 28 also may include a tongue scraper 32 positioned opposite the bristles and on a bottom side of brushing member 28. Tongue scraper 32 may include a textured surface such as one or more raised portions that form a pattern. One or more of bristles 30 and tongue scraper 32 may have an oral hygiene substance applied to its outer surface. This oral hygiene substance may include, in whole or in part, xylitol.

Handle members of the present disclosure may have any width, length, and shape but are preferably at least sufficiently long for a user to comfortably grasp the oral hygiene instrument in his or her hand. Further, when viewed from a top planar perspective (as shown in FIG. 4), the direction of bristles 30 may be substantially orthogonal to the orientation of flossing filament 26. This relationship, however, is not necessary. For example, in some embodiments, a flossing filament may be positioned such that it is substantially parallel to the bristles or fall somewhere between parallel and orthogonal relative to the bristles.

Embodiments of the oral hygiene instrument disclosed herein may include handle members that vary in width, length, and shape. For example, a handle member may be straight, or have a curve, as with elongated handle member 12. As disclosed in FIGS. 1 and 2, elongated handle member 12 is curved about an axis 34 such that top surface 14 of elongated handle member 12 forms a convex outer surface that faces away from axis 34 and bottom surface 16 of elongated handle member 12 forms a concave inner surface that faces toward axis 34.

A curved handle member may promote more efficient brushing and flossing. The curvature in elongated handle member 12 may facilitate brushing of the front sides of teeth in the first bicuspid, canine, and lateral incisor area. When an oral hygiene instrument having a straight handle member is used, the front sides of teeth in the first bicuspid, canine, and lateral incisor area may be missed when a user flips the instrument to focus on an opposite side of the mouth. A curved handle member, such as elongated handle member 12, may help correct this problem. In addition, handle members in alternative embodiments may have areas with different widths and thicknesses.

Flossing member 22 may be positioned at first end 18 of elongated handle member 12 such that flossing filament 26 is substantially parallel to axis 34. Brushing member 28 may be positioned at second end 20 of elongated handle member 12 such that bristles 30 extend away from axis 34. In alternative embodiments, a flossing member may be positioned at a first end of an elongated handle member such that a flossing filament member is not parallel to an axis about which an elongated handle member is curved. For example, a flossing filament may be positioned substantially perpendicular to an axis about which an elongated handle member is curved. Further, in other embodiments, an elongated handle member may be substantially flat such that it does not curve about any axis.

Elongated handle member 12, flossing member 22, and brushing member 28 may be a single unitary piece. Each of these components may be made from a recyclable material, such as polypropylene or (#1 or #2) polyethylene, and manufactured together as a single unit from an injectable mold.

Alternatively, elongated handle member 12, flossing member 22, and brushing member 28 may be manufactured separately and assembled prior to use. For example, a first coupling mechanism may selectively secure elongated handle member 12 to flossing member 22. A second coupling mechanism may selectively secure elongated handle member 12 to brushing member 28. First and second coupling mechanisms may be selectively engageable to allow a user to periodically replace flossing member 22 and brushing member 28. First and second coupling mechanisms may include a snap fit mechanism, a screw mechanism, a friction fit or another securing mechanism. In one embodiment of the present disclosure, elongated handle member 12 and brushing member 28 may be manufactured together as a single unitary member. Flossing member 22 may be selectively securable to elongated handle member 12 via a coupling mechanism, thus allowing a user to replace flossing member 22 when necessary, such as after each use.

Elongated handle member 12 may also include one or more digit placement pads, including thumb placement pads, which provide a surface or surfaces on which a user may place his or her finger(s) or thumb while flossing or brushing his or her teeth. Digit placement pads may include a non-slip coating, such as rubber, or have a textured surface to avoid a user's fingers or thumbs from slipping off of the placement pads while flossing and brushing.

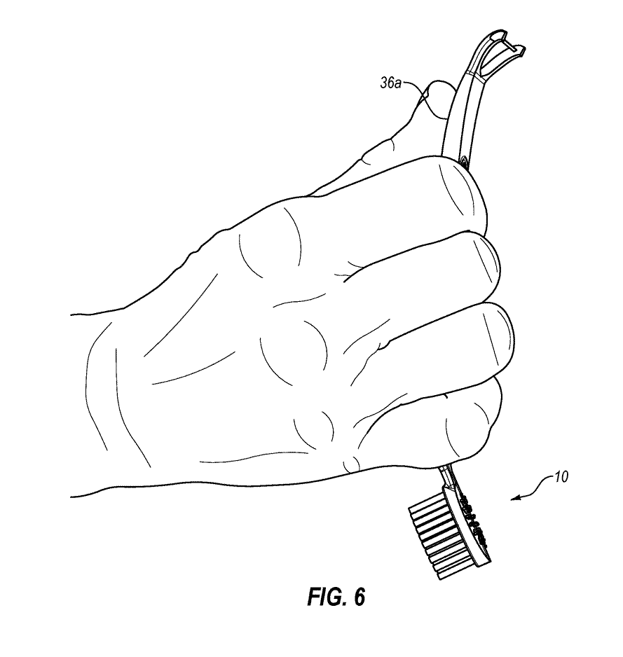

Oral hygiene instrument 10 may include a first thumb placement pad 36a on top surface 14 of elongated handle member 12. First thumb placement pad 36a may be positioned at or near first end 18 of elongated handle member 12. Placing a thumb on first thumb placement pad 36a may promote a positioning of oral hygiene instrument 10 within a user's hand that is useful for flossing between the user's upper teeth. FIG. 6 illustrates a user grasping oral hygiene instrument 10 with a thumb positioned on first thumb placement pad 36a such that oral hygiene instrument 10 is in a position within the user's hand that is useful for flossing between the user's upper teeth.

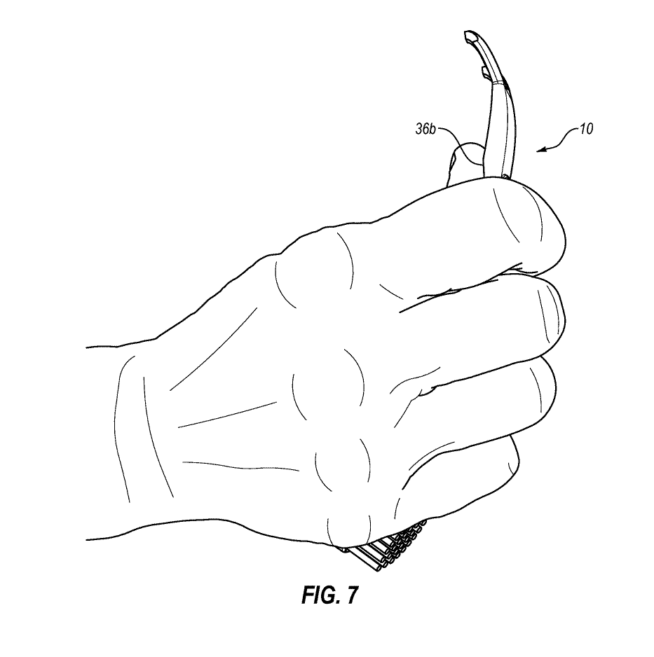

Oral hygiene instrument 10 may include a second thumb placement pad 36b on bottom surface 16 of elongated handle member 12. Second thumb placement pad 36b may be positioned at or near first end 18 of elongated handle member 12. Placing a thumb on second thumb placement pad 36b may promote a positioning of oral hygiene instrument 10 within a user's hand that is useful for flossing between the user's lower teeth. FIG. 7 illustrates a user grasping oral hygiene instrument 10 with a thumb positioned on second thumb placement pad 36b such that oral hygiene instrument 10 is in a position within the user's hand that is useful for flossing between the user's lower teeth.

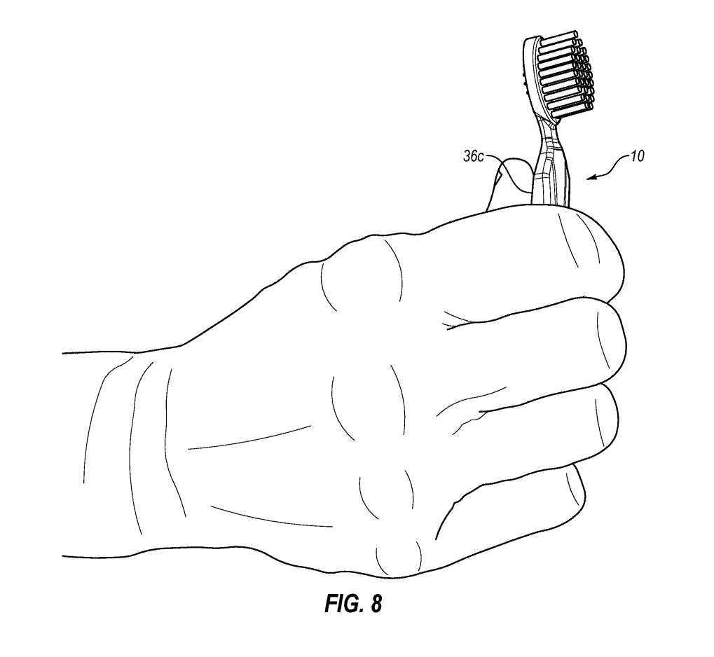

Oral hygiene instrument 10 may include a third thumb placement pad 36c on bottom surface 16 of elongated handle member 12. Third thumb placement pad 36c may be positioned at or near second end 20 of elongated handle member 12. Placing a thumb on third thumb placement pad 36c may promote a positioning of oral hygiene instrument 10 within a user's hand that is useful for brushing the user's upper teeth. FIG. 8 illustrates a user grasping oral hygiene instrument 10 with a thumb positioned on third thumb placement pad 36c such that oral hygiene instrument 10 is in a position within the user's hand that is useful for brushing the user's upper teeth.

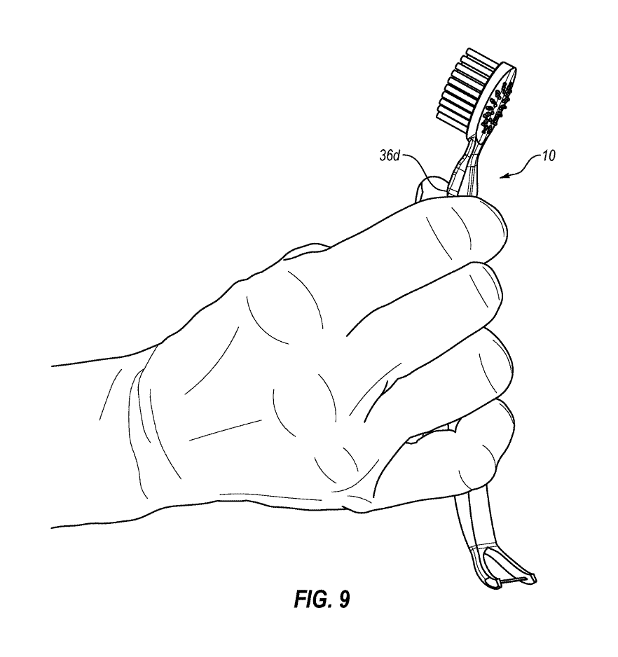

Oral hygiene instrument 10 may include a fourth thumb placement pad 36d on top surface 14 of elongated handle member 12. Fourth thumb placement pad 36d may be positioned at or near second end 20 of elongated handle member 12. Placing a thumb on fourth thumb placement pad 36d may promote a positioning of oral hygiene instrument 10 within a user's hand that is useful for brushing the user's lower teeth. FIG. 9 illustrates a user grasping oral hygiene instrument 10 with a thumb positioned on fourth thumb placement pad 36d such that oral hygiene instrument 10 is in a position within the user's hand that is useful for brushing the user's lower teeth.

Thumb placement pads 36a-d may also include a symbol, such as a number or a letter that indicates a proper sequence for flossing and brushing. For example, first thumb placement pad 36a may include the number 1, which provides the proper hand placement to facilitate flossing between the user's upper teeth and indicates that flossing between the user's upper teeth should be performed first. Second thumb placement pad 36b may include the number 2, which provides the proper hand placement to facilitate flossing between the user's lower teeth and indicates that flossing between the user's lower teeth should be performed second. Third thumb placement pad 36c may include the number 3, which provides the proper hand placement to facilitate brushing the user's upper teeth and indicates that brushing the user's upper teeth should be performed third. Fourth thumb placement pad 36d may include the number 4, which provides the proper hand placement to facilitate brushing the user's lower teeth and indicates that brushing the user's lower teeth should be performed fourth.

Embodiments of the oral hygiene instrument described herein may be disposable and designed for only a single use. For example, an oral hygiene substance may be pre-applied to flossing filament 26 and/or bristles 30 such that a user need not carry an oral hygiene substance, such as toothpaste, separately from the oral hygiene instrument itself. For example, Xylitol or a fluoridated toothpaste may be pre-applied onto flossing filament 26 and/or bristles 30.

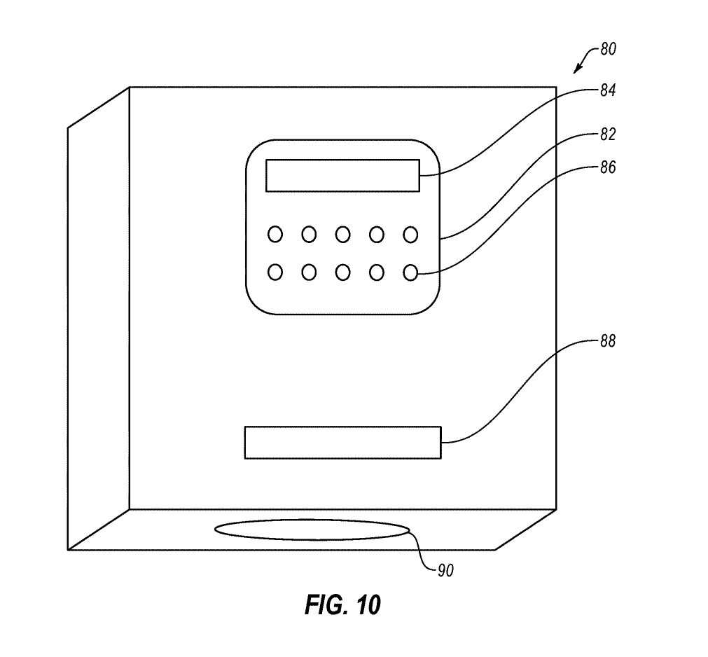

Embodiments of the oral hygiene instrument described herein may also be part of a larger oral hygiene system. The oral hygiene system of the present disclosure may include an oral hygiene instrument dispenser 80 as shown in FIG. 10. A number of oral hygiene instruments may be contained within dispenser 80. Oral hygiene instruments may be dispensed to users through dispenser hole 90. A sensor 88 may be included on a surface of dispenser 80. Sensor 88 may be a motion sensor that dispenses a single oral hygiene instrument when movement proximate to sensor 88 is sensed or when a code is read by the sensor 88, such as a bar code or the like. Sensor 88 may also sense a transmission of a contactless payment device, such as a credit card, debit card, key fob, smart card or other device, including smartphones and other mobile devices, that use radio-frequency identification (RFID) or near field communication (NFC) for making secure payments. These contactless payment systems include but are not limited to Google Pay and Apple Pay. These devices may contain embedded chips and antennas that enable consumers to place their card, fob, or handheld device over or proximate to sensor 88 in order to obtain an oral hygiene instrument from dispenser 80 for a fee.

Dispenser 80 may also include a keypad 82 containing input buttons 86 and a display screen 84. A person wanting to obtain an oral hygiene instrument may enter a sequence on input buttons 86 to obtain the instrument. For example, a person may have deposited money in a pre-paid account that may be drawn from by entering a code unique to that person. Display screen 84 may show the person how much money remains in the account. Alternatively, dispenser 80 may be placed at a commercial establishment, such as in a restaurant bathroom. As part of the user's meal, he or she may pay for an oral hygiene instrument. The user may then obtain a unique code that may be printed on a receipt from the user's meal. He or she may then use input buttons 86 to type that code into the dispenser 80 and obtain an oral hygiene instrument. Alternatively, the sensor 88 can read a bar code or other printed code on the receipt or other printed medium.

Before being placed into dispenser 80, oral hygiene instruments may be individually packaged. Placing individual instruments in packaging may prevent the instrument from getting dirty or damaged while in dispenser 80 or after being dispensed should the instrument, for example, fall to the ground. The packaging may be sterile.

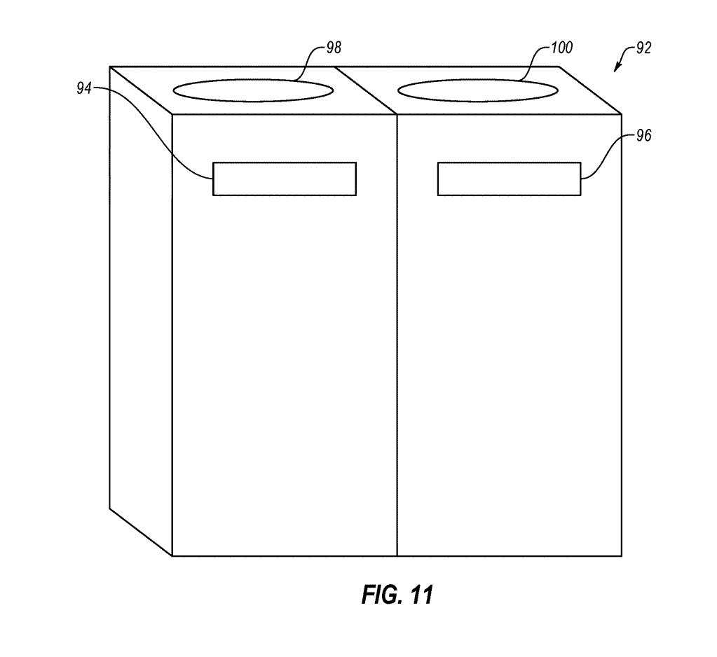

The oral hygiene system of the present disclosure may also include a receptacle 92, as shown in FIG. 11, for receiving packaging and/or used oral hygiene instruments. Receptacle 92 may contain a single bin or multiple bins. Receptacle 92 is shown in FIG. 11 to contain two separate bins, each having its own opening 98 or 100 and each having its own sensor 94 or 96. One bin may be designed and configured to receive the packaging in which an oral hygiene instrument is dispensed. The other bin may be designed and configured to receive used oral hygiene instruments. Separating the packaging from the instrument may facilitate the recycling of these products. Receptacle 92 may include writing or pictures showing the proper bin to place either the packaging or used oral hygiene instrument. In addition or alternatively, openings 98 and 100 may be shaped and sized to accept the appropriate waste. For example, the bin designated to receive used oral hygiene instruments may have an opening that is in the shape of the instrument. The bin designated to receive packaging may be smaller such that the instrument would not fit into that opening.

Openings 98 and 100 may include doors that are opened by activating one of sensors 94 and 96. For example, a bar code may be placed on an oral hygiene instrument, for example on a surface of an elongated handle member (for example, bar code 38 on hygiene instrument 10 shown in FIG. 1). A separate bar code may be placed on the packaging that contains the instrument. Sensors 94 and 96 may be bar code scanners. Upon scanning the bar code contained on either the instrument or its packaging, the door to the appropriate bin may be configured to open allowing the user to place the instrument or its packaging in the appropriate bin. Receptacle 92 may have a single sensor to accomplish this function or multiple sensors.

Dispenser 80 and receptacle 92 may be a single dispensing and receiving unit or they may be separate from one another. In addition, dispenser 80 and/or receptacle 92 may contain information or its own bar code or scannable device that a user may scan to obtain information about the product, how to use it, and how to dispose of the waste after use. For example, dispenser 80 and/or receptacle 92 may identify an informative website that a user may visit to obtain important information. Alternatively, dispenser 80 and/or receptacle 92 may have a device that may be scanned or sensed by a user's phone to automatically bring up the informative website.

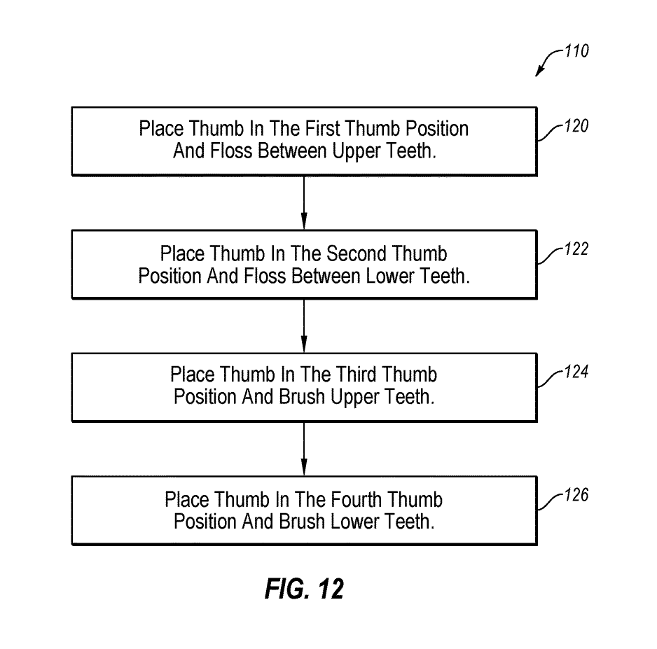

The present disclosure may also include a method 100, illustrated in FIG. 12, for using an oral hygiene instrument according to the present disclosure. In a first step 120, a user places his or her thumb in a first thumb position (for example, first thumb placement pad 36a labeled with the number 1 on oral hygiene instrument 10 of FIGS. 1-5), which orients the user's hand appropriately on the oral hygiene instrument to facilitate flossing between the user's upper teeth. This hand placement is illustrated in FIG. 6.

In a second step 122, a user places his or her thumb in a second thumb position (for example, second thumb placement pad 36b labeled with the number 2 on oral hygiene instrument 10 of FIGS. 1-5), which orients the user's hand appropriately on the oral hygiene instrument to facilitate flossing between the user's lower teeth. This hand placement is illustrated in FIG. 7.

In a third step 124, a user places his or her thumb in a third thumb position (for example, third thumb placement pad 36c labeled with the number 3 on oral hygiene instrument 10 of FIGS. 1-5), which orients the user's hand appropriately on the oral hygiene instrument to facilitate brushing the user's upper teeth. This hand placement is illustrated in FIG. 8.

In a fourth step 126, a user places his or her thumb in a fourth thumb position (for example, fourth thumb placement pad 36d labeled with the number 4 on oral hygiene instrument 10), which orients the user's hand appropriately on the oral hygiene instrument to facilitate brushing the user's lower teeth. This hand placement is illustrated in FIG. 9.

Written instructions teaching this method and containing pictures illustrating the same may be printed on the packaging of an oral hygiene instrument. It may also be printed on dispenser 80 and/or receptacle 92 illustrated in FIGS. 10 and 11, respectively.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. An oral hygiene instrument comprising:
an elongated handle member including a top surface, a bottom surface, a first end and a second end;
a flossing member at the first end of the elongated handle member, the flossing member including a filament holding member and a flossing filament for flossing between teeth,
a brushing member at the second end of the elongated handle member, the brushing member including a plurality of substantially parallel bristles for brushing teeth; and
an oral hygiene substance applied to the flossing filament of the flossing member and the bristles of the brushing member.

2. The oral hygiene instrument of claim 1 further comprising:
a first coupling mechanism at the first end of the elongated handle member, the first coupling mechanism configured to selectively engage the flossing member; and
a second coupling mechanism at the second end of the elongated handle member, the second coupling mechanism configured to selectively engage the brushing member.

3. The oral hygiene instrument of claim 1, wherein:
at least a portion of the elongated handle member is curved about an axis such that at least a portion of the top surface of the elongated handle member forms a convex outer surface that faces away from the axis and at least a portion of the bottom surface of the elongated handle member forms a concave inner surface that faces toward the axis, and
the brushing member is positioned such that the plurality of bristles extend away from the axis.

4. The oral hygiene instrument of claim 3, wherein the flossing filament is substantially parallel to the axis.

5. The oral hygiene instrument of claim 1, wherein the oral hygiene substance includes xylitol.

6. The oral hygiene instrument of claim 1 further comprising a first thumb placement pad and a second thumb placement pad positioned at or near the first end of the elongated handle member, the first and second thumb placement pads being configured such that when a user places a thumb on the first or second thumb placement pads and grasps the elongated handle member, the oral hygiene instrument is positioned to floss the user's teeth.

7. The oral hygiene instrument of claim 6 further comprising a third thumb placement pad and a forth thumb placement pad positioned at or near the second end of the elongated handle member, the third and fourth thumb placement pads being configured such that when a user places a thumb on the third or fourth thumb placement pads and grasps the elongated handle member, the oral hygiene instrument is positioned to brush the user's teeth.

8. The oral hygiene instrument of claim 7, wherein the first, second, third, and fourth thumb placement pads include symbols that indicate a proper sequence of brushing and flossing.

9. The oral hygiene instrument of claim 7, wherein the first, second, third, and fourth thumb placement pads include an anti-slip texture.

10. An oral hygiene instrument comprising:
an elongated handle member including a top surface, a bottom surface, a brushing end, and a flossing end;
a brushing member at the brushing end, the brushing member including a plurality of bristles for brushing teeth;
a flossing member at the flossing end, the flossing member including a flossing filament holding member and a flossing filament for flossing between teeth;
a first thumb placement pad and a second thumb placement pad positioned on the elongated handle member at or near the flossing end, the first thumb placement pad being positioned on the top surface of the elongated handle member and the second thumb placement pad being positioned on the bottom surface of the elongated handle member; and
a third thumb placement pad and a fourth thumb placement pad positioned on the elongated handle member at or near the brushing end, the third thumb placement pad being positioned on the bottom surface of the elongated handle member and the fourth thumb placement pad being positioned on the top surface of the elongated handle member.

11. The oral hygiene instrument of claim 10, wherein each of the first, second, third, and fourth thumb placement pads includes a different symbol that indicates a proper sequence of brushing and flossing.

12. The oral hygiene instrument of claim 11, wherein each different symbol is a number.

13. The oral hygiene instrument of claim 11, wherein the first, second, third, and fourth thumb placement pads include an anti-slip texture.

14. The oral hygiene instrument of claim 11, wherein:
at least a portion of the elongated handle member is curved about an axis such that the top surface of the elongated handle member forms a convex outer surface that faces away from the axis and the bottom surface of the elongated handle member forms a concave inner surface that faces toward the axis, and
the brushing member is positioned such that the plurality of bristles extend away from the axis.

15. The oral hygiene instrument of claim 14, wherein the flossing filament is substantially parallel to the axis.

16. The oral hygiene instrument of claim 10 further comprising an oral hygiene substance pre-applied to the bristles of the brushing member and the flossing filament of the flossing member.

17. The oral hygiene instrument of claim 16, wherein the oral hygiene substance includes xylitol.

18. A method for oral hygiene comprising:
obtaining an oral hygiene instrument, the oral hygiene instrument including:
an elongated handle member including a top surface, a bottom surface, a brushing end, and a flossing end;
a brushing member at the brushing end, the brushing member including a plurality of bristles for brushing teeth;
a flossing member at the flossing end, the flossing member including a flossing filament holding member and a flossing filament for flossing between teeth,
a first thumb placement pad and a second thumb placement pad positioned on the elongated handle member at or near the flossing end, the first thumb placement pad being positioned on the top surface of the elongated handle member and the second thumb placement pad being positioned on the bottom surface of the elongated handle member, and
a third thumb placement pad and a fourth thumb placement pad positioned on the elongated handle member at or near the brushing end, the third thumb placement pad being positioned on the top surface of the elongated handle member and the fourth thumb placement pad being positioned on the bottom surface of the elongated handle member.
grasping the oral hygiene instrument with a thumb on the first thumb placement pad and flossing between a user's upper teeth;
grasping the oral hygiene instrument with a thumb on the second thumb placement pad and flossing between the user's lower teeth;
grasping the oral hygiene instrument with a thumb on the third thumb placement pad and brushing the user's upper teeth; and
grasping the oral hygiene instrument with a thumb on the fourth thumb placement pad and brushing the user's lower teeth.

19. The oral hygiene method of claim 18, wherein the first, second, third, and fourth thumb placement pads include symbols that indicates a sequence of flossing and brushing.

20. The oral hygiene method of claim 19, wherein the symbols are numbers.
